(19) United States
(12) Patent Application Publication
(10) Pub. No.: US 2012/0246650 A1
(43) Pub. Date: Sep. 27, 2012

(54) METHOD FOR PROCESSING INFORMATION AND ACTIVITIES IN A CONTROL AND/OR REGULATING SYSTEM WITH THE AID OF A MULTI-CORE PROCESSOR

(76) Inventors: Bernd Mueller, Leonberg (DE); Markus Ferch, Grossbottwar (DE); Yorck von Collani, Beilstein (DE); Holger Banski, Santa Clara, CA (US)

(21) Appl. No.: 13/497,021

(22) PCT Filed: Sep. 16, 2010
(86) PCT No.: PCT/EP10/63611

§ 371 Date: Jun. 1, 2012

(30) Foreign Application Priority Data
Sep. 21, 2009 (DE) 10 2009 028 642.5

(51) Int. Cl. G06F 9/46

(52) U.S. Cl. 718/100

(57) ABSTRACT

A method for processing information and activities in a control and/or regulating system in which the control and/or regulating tasks are performed by a microcontroller, the control/regulating system including different components and the microcontroller receiving information which is evaluated and processed thereby, and at least one output signal being output as the result of control/regulating calculations. In a method for processing information and activities in a control and/or regulating system which may be implemented cost-effectively and nevertheless permits high computing power, the control and regulating tasks of the system are divided into component-specific task complexes, a first component-specific task complex being processed by a first processor core of the microcontroller and a second component-specific task complex being processed by a second processor core of the microcontroller.

### FIELD OF THE INVENTION

The present invention relates to a method for processing information and activities in a control and/or regulating system in which the control and/or regulating tasks are carried out by a microcontroller, the control and regulating system including different components and the microcontroller receiving information which is evaluated and processed thereby, and at least one output signal being output as the result of control and/or regulating calculations; the present invention also relates to a device for carrying out the method.

### BACKGROUND INFORMATION

In today's control and regulating systems, as represented by a motor vehicle, for example, a plurality of electronic components are used for control and regulation which usually have elements such as at least one sensor, one processing unit and at least one actuator. Microcontrollers which are installed in a control unit are used to process information of the sensor and to calculate the control commands for the actuator. If only one microcontroller is used, either the sensor values may be read in and evaluated or the actuators are calculated at a given point in time, due to the limited computing power of the microcontroller.

A method for processing information and activities which arise, in particular when controlling internal combustion engines, which works with two controllers installed in a control unit is discussed in DE 40 04 516 A1. The calculation-intensive information and activities which arise on different processing levels are carried out independently of each other by the two controllers. A time-synchronous level is processed by a first controller and an angle-synchronous level by a second controller. The number of controllers increases as the functional scope rises, which results in a cost-intensive control unit.

### SUMMARY OF THE INVENTION

An object of the exemplary embodiments and/or exemplary methods of the present invention is to specify a method and a device for processing information and activities in a control and/or regulating system which may be implemented cost-effectively and nevertheless have a high computing power.

According to the exemplary embodiments and/or exemplary methods of the present invention, the object is achieved in that the control and regulating tasks of the system are divided into component-specific task complexes, a first component-specific task complex being processed by a first processor core of the microcontroller and a second component-specific task complex being processed by a second processor core of the microcontroller. The advantage of the present invention is that the use of a multi-core microcontroller results in an effective way to decouple the control and regulating tasks of the system, thus achieving a high effective computing power, since each processor core processes tasks of a different type at a predefined point in time. The computing power of the microcontroller is used more effectively in this way. It is thus also possible to dispense with the use of multiple microcontrollers.

The first component-specific task complex is advantageously processed by the first processor core at the same time that the second component-specific task complex is processed by the second processor core. By processing different component-specific task complexes simultaneously on different processor cores of a microcontroller, the overall tasks are parallelized in the system, thus also reducing the complexity of the processes on the microcontroller.

In one embodiment, the first component-specific task complex includes the reading in and/or processing of information of a sensor by the first processor core, and the second component-specific task complex includes the control and/or regulation of an actuator by the second processor core. The component-specific task complexes are oriented toward components which are situated externally in relation to the microcontroller, such as sensor and actuator. Since the evaluation of sensor information is frequently very complex, controlling the actuator no longer has to wait until the evaluation of the sensor information is completed, due to the method according to the present invention, since the information of the sensor is read in and/or evaluated on one processor core while the control signal for the actuator is calculated on the other processor core.

In one refinement, a third component complex is a processing operation carried out by a third processor core of the microcontroller in which the sensor information prepared by the first processor core is evaluated and the control and regulating calculations are carried out, whose output values are output to the second arithmetic unit for controlling the actuator. The processing operation involves performing a regulating task, the result of this task being to provide output data for the actuator. Since this task may take a highly complex form, it is viewed as an independent, component-dependent task which is processed on a separate processor core, which helps further decouple the complexity of the microcontroller. The computing power is further increased by the use of a third processor core. The number of processor cores which may be efficiently used with the aid of this method depends on how many component-specific task complexes are differentiated in the control and regulating system. The computing power of the system is thus further increased and the parallelism in which the tasks are processed is improved.

The first and the second and/or the third processor cores advantageously exchange data simultaneously with at least one memory unit via a communication system of the control and regulating system. The parallel processes within the microcontroller are not limited only to the processing by the processor cores but also apply to the communication system, which may be designed as a bus, crossbar or internal microcontroller communication system. This ensures that at least two processor cores are able to access the memory at the same time. A bus arbitration also does not result in sequentialization.

In one embodiment, the characteristic of a control signal of the actuator is shaped during control on the basis of the simultaneously read-in sensor information. Due to the fact that the sensor signals are evaluated in the first processor core in parallel to the determination of the actuator signal by the second processor core, the actuator signal may be adapted directly to the latest sensor value, thus resulting in a highly accurate shaping of the actuator control function. This is possible only because a high computing power is provided, due to the processing of the tasks on different processor cores.

In one refinement, an error detection mechanism of the first, the second or the third processor core functions independently of the path of the control and/or regulation. Separating the control and/or regulation from monitoring thus makes it possible to implement the control and regulating tasks very quickly, very accurately and thus in a way that improves error coverage.

In one variant, the error detection mechanism is processed by an additional, e.g., fourth, processor core of the microcontroller. By using a fourth processor core, the monitoring path acts across components and is independent of the path to be controlled. Multiple sensors and multiple actuators may therefore be monitored at the same time.

In one advantageous specific embodiment, the control and/or regulating system is a motor vehicle system. The method according to the present invention is suitable, in particular, for motor vehicles where numerous, highly complex control and regulating tasks must be processed, such as steering, braking and damping, these individual tasks each requiring high computing power. The use of a multi-core controller for each of the aforementioned control and regulating complexes reduces the cost of constructing a control unit.

Another refinement of the exemplary embodiments and/or exemplary methods of the present invention relates to a device for processing information and activities in a control and/or regulating system in which the control and/or regulating tasks are carried out by a microcontroller, the control and regulating system including different components and the microcontroller receiving information which is evaluated and processed thereby, and at least one output signal being output as the result of control and/or regulating calculations. To provide a device for processing information and activities in a control and/or regulating system which is cost-effective to manufacture and which nevertheless has a high computing power, means are provided which divide the control and regulating tasks of the system into component-specific task complexes, a first component-specific task complex being processed by a first processor core of the microcontroller and a second component-specific task complex being processed by a second processor core of the microcontroller. This has the advantage that the software-based combination of component-dependent task complexes results in an effective way to decouple the control and regulating tasks of the system, thus achieving a high computing power, since each processor core processes tasks of a different type at a predefined point in time. The use of a multi-core controller utilizes the computing power of the microcontroller more effectively, making it possible to dispense with the use of multiple microcontrollers.

Advantageously, the first processor core is connected to a sensor via a first interface, and the second processor core is connected to an actuator via a second interface. The direct connection of the processor cores to external components of the control and regulating system permits a structurally simple connection of the microcontroller.

In one embodiment, the control and regulating system has a communication system which simultaneously connects both the first processor core and the second processor core to at least one memory unit, in particular a random access memory or a read-only memory. This ensures that at least two processor cores are able to access the memory at the same time. The parallel structure of the communication system prevents sequentialization of the signals to be transmitted.

In one refinement, the microcontroller has a third processor core for evaluating the sensor information prepared by the first processor core and for executing the control and regulating calculations, whose output values are output to the second arithmetic unit for controlling the actuator, and/or a fourth processor core for the error detection mechanism of the system. Depending on the number of task complexes to be processed parallel to each other, a multi-core controller of this type is selected which includes the necessary number of processor cores needed for the task complexes to be processed simultaneously in parallel.

The present invention permits numerous specific embodiments. One of these specific embodiments is explained in greater detail on the basis of the figures illustrated in the drawings. Identical features are identified by identical reference numerals.

### BRIEF DESCRIPTION OF THE DRAWINGS

FIG. 1 shows a schematic diagram of the general system context according to the related art.

FIG. 2 shows a schematic diagram of the device according to the present invention.

FIG. 3 shows a schematic flow chart for the method for processing information and activities in a control and/or regulating system.

### DETAILED DESCRIPTION

FIG. 1 shows a motor vehicle as a control and regulating system, including its principal components. The system includes a sensor element 1, which supplies information to a processing unit 2. Processing unit 2 processes and evaluates the data supplied by sensor element 1 and calculates output data which are passed on to an actuator 3. In this case, sensor element 1 may supply analog or digital values. These values may reach processing unit 2 via a bus system or a special sensor interface, using A/D (analog/digital) channels. Sensor element 1 may measure a current or a voltage value, a position or an angle, a pressure or a torque or much more. In a real-time system, such as that represented by a motor vehicle, the task of reading in and processing the sensor values is highly complex. On the one hand, this is due to the fact that the sensor values must be updated very frequently. On the other hand, subsequent processing is always necessary, which may involve, for example, forming a mean value, filtering, smoothing, or checking for plausibility.

Processing the prepared sensor data by processing unit 2 frequently involves performing a regulating task, but it may also be based on other types of algorithms. Output data for actuator 3 are provided as the result of processing the sensor data.

Controlling actuator 3 is a complex task. During fuel injection of the internal combustion engine, for example, it involves multiple different individual injections which may also have different configurations.

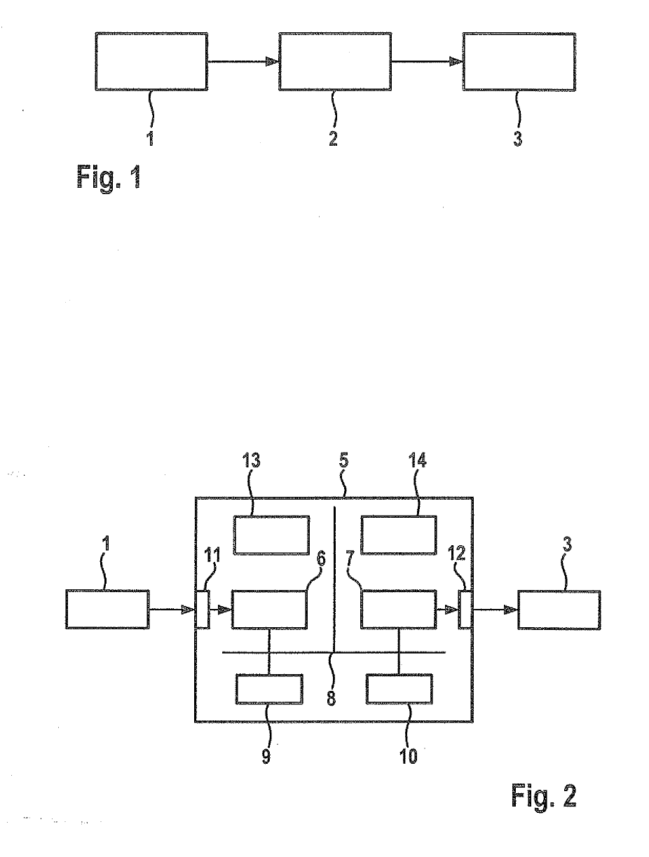

FIG. 2 shows the described system having a multi-core microcontroller 5. Multi-core microcontroller 5 has four processor cores 6, 7, 13 and 14. Processor cores 6, 7, 13, 14 are connected to each other and to a random access memory 9 (RAM) and a read-only memory 10 (ROM) via an internal communication system 8. Sensor element 1 leads to first processor core 6 via a first interface 11, while second processor core 7 leads to actuator 3 via a second interface 12.

Internal communication system 8 is designed in such a way that it permits multiple processor cores 6, 7, 13, 14 to access read-only memory 10 and/or random access memory 9 at the same time.

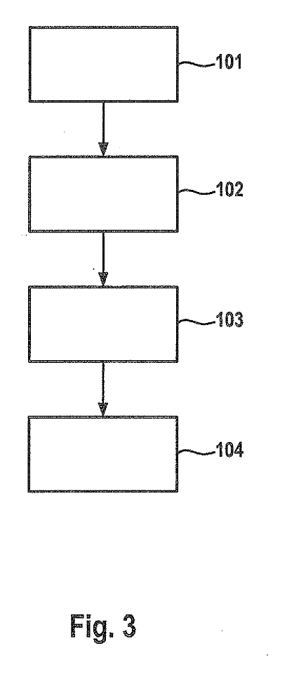

The sequence of the method according to the present invention is explained on the basis of FIG. 3. In block 101, processor core 6 reads in a sensor value via interface 11 and carries out the sensor data detection and preparation. In block 102, the prepared sensor data are supplied to other processor cores via internal communication system 8, for example to processor core 13, which uses the sensor data to perform a regulating task and determines the output data for actuator 3. These output data are then made available to the other processor cores via internal communication system 8. For example, processor core 7 may determine control parameters for actuator 3 from the available data and control actuator 3 via interface (block 103). In block 104, the processes in processor cores 6, 7, and 13 and sensor element 1 as well as actuator 3 are monitored by processor core 14, in which an error detection mechanism is stored. This error monitoring takes place independently of processor cores 6, 7, 13, which perform the control and regulating tasks.

The method may be used with more or even fewer processor cores. If the processing step is very simple, for example, it may also be handled by processor core 6 or 7. In this case, it is then still possible to parallelize the actuator control and the sensor processing. If independent error monitoring is not necessary, corresponding processor core 14 may also be dispensed with, so that the object of the method may also be represented on a dual-core system. If multiple sensors in the system play a role, these sensors may be read in and processed on one processor core 7, or multiple processor cores (for example, one per sensor) may also be used.

A useful application of the method according to the present invention on two processor cores may be implemented for monitoring purposes. In this case, one of the two cores controls an actuator, for example of an injection system or an electric motor. In many applications which are implemented in embedded systems (for example in motor vehicles), it is important to monitor this control, i.e., to ensure that the desired result of the control is actually achieved in the system. It is then advantageous to check via a sensor, which also measures this result, whether the active chain from control to actuator(s) functions correctly. For the system, the result may be measured as directly as possible using the sensors; however, it is often necessary to calculate the result from the measured variables using a model. It may also require a considerable amount of computing effort to calculate this result. It is therefore advantageous for performance reasons alone to use the method according to the present invention and to perform this sensor evaluation and possibly also a comparison with the desired result on the second core. Safety concerns are also a good reason to use this method, since the second core is an independent check of the active chain which runs via the first core. In this case, it is also advantageous if suitable hardware measures, for example exclusive accessibility to the sensor interface, are carried out to ensure that only the second core receives the sensor values directly, since this means that the independence on the system level is even more pronounced. With regard to safety, the use of the method has the additional advantage of a shorter error detection time, since the monitoring runs in parallel in real time. It is thus possible to respond appropriately even in the event of minor deviations, for example by sending a message from the monitoring core to the active core and thus initiating counter-measures at an early point. This enhancement then even ensures increased availability.

A useful enhancement of the method would also be if the results of (all or individual) processor cores were written to random access memory 9, which the other processor cores were then able to access, via communication system 8.

This method may also be effectively used, in particular, in a periodic system, for example if one processor core uses data in a cycle which the other processor cores have calculated in the preceding cycle.

This method may be effectively used even if two operations are to be carried out in parallel over time. For example, if the latest sensor values are to be taken into account for controlling an actuator, this method may be used to implement the parallelism. This parallelism may then be used to represent a chronologically high resolution characteristic shaping of a control signal or also to implement a very precise monitoring.

A plurality of possible applications for the exemplary embodiments and/or exemplary methods of the present invention exists in motor vehicles. If fuel injection is used as an actuator in a vehicle system, multiple injection nozzles representing actuators 3, multiple sensor elements 1 are needed to correctly set the actuators. For example, the rail pressure, the combustion chamber pressure in the cylinders, the exhaust gas temperature and the lambda factor must be measured as sensor data.

In a brake system, either a valve or an electric motor is used as actuator 3. The brake pressure and the wheel rotational speeds must be detected to correctly control these actuators.

In the area of the vehicle body, a lamp is used as the actuator, while a button setting is evaluated as the sensor value.

1-13. (canceled)

14. A method for processing information and activities in a control/regulating system in which the control and/or regulating tasks are carried out by a microcontroller, the control/regulating system including different components, the method comprising:
receiving, at the microcontroller, information which is evaluated and processed thereby;
dividing the control and regulating tasks of the system into component-specific task complexes;
processing a first component-specific task complex by a first processor core of the microcontroller;
processing a second component-specific task complex by a second processor core of the microcontroller; and
outputting at least one output signal as the result of control and/or regulating calculations;
wherein the first component-specific task complex includes at least one of reading in and preparing information of a sensor by the first processor core, and wherein the second component-specific task complex includes controlling and/or regulating an actuator by the second processor core.

15. The method of claim 14, wherein the first component-specific task complex is processed by the first processor core at the same time that the second component-specific task complex is processed by the second processor core.

16. The method of claim 15, wherein a third component-specific complex is a processing operation carried out by a third processor core of the microcontroller in which the sensor information prepared by the first processor core is evaluated and the control and regulating calculations are carried out, whose output values are output to the second processing core for controlling the actuator.

17. The method of claim 16, wherein the first processor core and the second processor core and/or the third processor core simultaneously exchange data with at least one memory unit via a communication system.

18. The method of claim 16, wherein a characteristic of a control signal of the actuator is shaped during its control based on the simultaneously read-in sensor information.

19. The method of claim 14, wherein an error detection mechanism of the first processor core, the second processor core and the third processor core functions independently of the path of the control and/or regulation.

20. The method of claim 19, wherein the error detection mechanism is processed by a fourth processor core of the microcontroller.

21. The method of claim 14, wherein the control and/or regulating system is a motor vehicle system.

22. A device for processing information and activities in a control and/or regulating system in which the control and/or regulating tasks are carried out by a microcontroller (5), the control and regulating system including different components (1, 2, 3) and the microcontroller (5) receiving information which is evaluated and processed thereby, and at least one output signal being output as the result of control and/or regulating calculations, wherein means (5) are provided which divide the control and regulating tasks of the system into component-specific task complexes, a first component-specific task complex being processed by a first processor core (6) of the microcontroller (5) and a second component-specific task complex being processed by a second processor core (7) of the microcontroller (5), wherein the first component-specific task complex includes the reading in and/or preparation of information of a sensor (1) by the first processor core (6), and the second component-specific task complex includes the control and/or regulation of an actuator (3) by the second processor core (7).

23. The device of claim 22, wherein the first processor core is connected to a sensor via a first interface, and the second processor core is connected to an actuator via a second interface.

24. The device of claim 23, wherein the control and regulating system has a communication system which simultaneously connects both the first processor core and the second processor core to at least one memory unit, which includes a random access memory or a read-only memory.

25. The device of claim 24, wherein the microcontroller has a third processor core for evaluating the sensor information prepared by the first processor core and for executing the control and regulating calculations whose output values are output to the second processor core for controlling the actuator, and/or a fourth processor core for the error detection mechanism of the system.
